(19) United States
(12) Patent Application Publication
(10) Pub. No.: US 2007/0171805 A1
(43) Pub. Date: Jul. 26, 2007

(54) Optical disc apparatus and laser power control method

(75) Inventors: Kazutoshi Shigeta, Ikoma (JP); Osamu Kawamae, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 11/641,298

(22) Filed: Dec. 18, 2006

(30) Foreign Application Priority Data
Dec. 28, 2005 (JP) 2005-376852
Nov. 7, 2006 (JP) 2006-301352

(51) Int. Cl. G11B 7/00

(52) U.S. Cl. 369/116

(57) ABSTRACT

In laser power control, optical and electronic components are subjected to correction on their temperature characteristics to stabilize write/read characteristics. The present invention comprises a power detector which detects the power of laser light generated by a pickup, a temperature detector which detects the temperature in the pickup, a calculating unit which calculates a target value of the power of laser light generated by the pickup according to the detected temperature, and a power control unit which performs control so that the pickup generates laser light with the power based on the target value. The calculating unit sets a target value so that the characteristics of an objective lens and the power detector in the pickup may be corrected based on their temperature characteristics.

### CLAIM OF PRIORITY

The present application claims priority from Japanese applications Serial No. JP 2005-376852, filed on Dec. 28, 2005 and Serial No. JP 2006-301352, filed on Nov. 7, 2006, the contents of which are hereby incorporated by references into this application.

### BACKGROUND OF THE INVENTION

(1) Field of the Invention

The present invention relates to an optical disc apparatus and a laser power control method which control with high accuracy the laser power applied to an optical disc.

(2) Description of the Related Art

With an optical disc apparatus, when applying laser light to an optical disc at the time of writing or reading, control is performed so that the laser light power remains constant in order to stabilize the quality of writing or reading. Therefore, an employed feedback control (APC: Automatic Power Control) is such that the power of the light emitted from a laser light source is detected and the intensity remains constant.

Japanese Patent Laid-open No. 2005-228433 describes measures to be taken when characteristics of an amplifier circuit for a monitor signal (power detection signal) fluctuate in response to the ambient temperature. Specifically, with an emission power control apparatus which controls the emission power of the laser light source based on a target value of the emission power and the monitor signal which is detected from actual emission power, Reference 1 discloses a configuration including an amplifier circuit which amplifies the monitor signal, temperature detection means for detecting the temperature near the amplifier circuit, and means for giving the amplifier circuit a signal for eliminating an offset component based on a temperature detection signal detected by the temperature detection means.

### SUMMARY OF THE INVENTION

With the increase in the recording density, an optimal margin of the laser power at the time of write/read operation is becoming narrower. To ensure the write/read quality, it is necessary to control the irradiation power with high accuracy.

For this purpose, it is necessary to exactly perform correction with respect to ambient temperature change taking into consideration the temperature characteristics of optical and electronic components constituting an optical pickup. For example, the transmission factor of an objective lens changes with the ambient temperature, and the detection sensitivity of a front monitor detector (FMD), which is a power detector, also has temperature characteristics. As a result, if the ambient temperature changes, the power actually applied to the optical disc surface may deviate from an optimum value in spite of normal operation of APC control. However, this problem was taken into consideration neither by the above-mentioned Japanese Patent Laid-open No. 2005-228433 nor by the related art.

An object of the present invention is to make correction for temperature characteristics of optical and electronic components to stabilize write/read characteristics in laser power control.

An optical disc apparatus of the present invention comprises: a pickup which generates laser light and applies it to an optical disc; a power detector which detects the power of laser light generated by the pickup; a temperature detector which detects temperature in the pickup; a calculating unit which calculates a target value of the power of laser light generated by the pickup according to the detected temperature; and a power control unit which compares power detected by the power detector with a target value calculated by the calculating unit and then performs control so that the pickup generates laser light with the power based on the target value.

The optical disc apparatus further comprises: a memory which stores correction data used for correcting temperature characteristics of transmission factor of an objective lens in the pickup, wherein the calculating unit calculates a target value of the power of laser light using the correction data stored in the memory.

The optical disc apparatus further comprises: a memory which stores correction data used for correcting temperature characteristics of detection sensitivity of a power detector in the pickup, wherein the calculating unit calculates a target value of the power of laser light using the correction data stored in the memory.

The present invention is a laser power control method in an optical disc apparatus, the method comprising the steps of: detecting temperature in the pickup which applies laser light to an optical disc; detects the power of laser light generated by the pickup; setting a target value of the laser light power according to the detected temperature; and performing control so that the pickup generates laser light with the power based on the set target value.

An optical disc apparatus of the present invention comprises: a pickup which generates laser light and applies it to an optical disc; a power detector which detects writing power of laser light generated by the pickup; a temperature detector which detects temperature in the pickup; a write signal processing unit which converts the data to be written into a signal with a predetermined format and supplies it to the pickup; an interval detecting unit which gives an instruction for performing a writing power optimization process at predetermined intervals, a calculating unit which calculates the amount of writing power correction of laser light generated by the pickup according to the detected temperature and at the same time calculates the amount of writing power correction by evaluating the quality of written data in the writing power optimization process; and a writing power control unit which sets new writing power of laser light generated by the pickup, based on each of the amounts of correction calculated by the calculating unit.

The above-mentioned calculating unit holds target quality for each record position of an optical disc in advance, and calculates the amount of writing power correction by comparing the quality of written data with the target value in the writing power optimization process. The above-mentioned interval detecting unit sets an interval at which the writing power optimization process is to be performed according to a tolerance range of the writing power in the optical disc.

The laser power control method of the present invention comprises the steps of: detecting temperature in the pickup which applies laser light to an optical disc; detecting the writing power of laser light generated by the pickup; calculating the amount of correction of the writing power detected according to the detected temperature and at the same time reading written data by once stopping write operation as a writing power optimization process; calculating the amount of writing power correction by comparing the quality of read data with target quality; and setting new writing power of laser light based on each of the calculated amounts of correction.

When the above-mentioned optimization process is performed, the optimization process is performed again immediately thereafter with regard to the data written by the newly set writing power.

In accordance with the present invention, it is possible to realize write/read characteristics which are stable and favorable even if the ambient temperature changes.

### BRIEF DESCRIPTION OF THE DRAWINGS

FIG. 1 is a block diagram showing an embodiment of an optical disc apparatus according to the present invention.

FIG. 2 is a diagram showing an example of internal configuration of a pickup.

FIG. 3 is a diagram showing the temperature characteristics of an objective lens and the corrected characteristics.

FIG. 4 is a diagram showing the temperature characteristics of a front monitor detector (FMD) and the corrected characteristics.

FIG. 5 is a flowchart showing an embodiment of laser power control method according to the present invention.

FIG. 6 is a block diagram showing another embodiment of an optical disc apparatus according to the present invention.

FIG. 7 is a diagram showing an example of a target value used when evaluating the quality of written data.

FIG. 8 is a diagram showing an example of a timing at which Walking-OPC is performed.

### DETAILED DESCRIPTION OF THE PREFERRED EMBODIMENTS

Embodiments of the present invention will be described below with reference to the accompanying drawings.

### EMBODIMENT 1

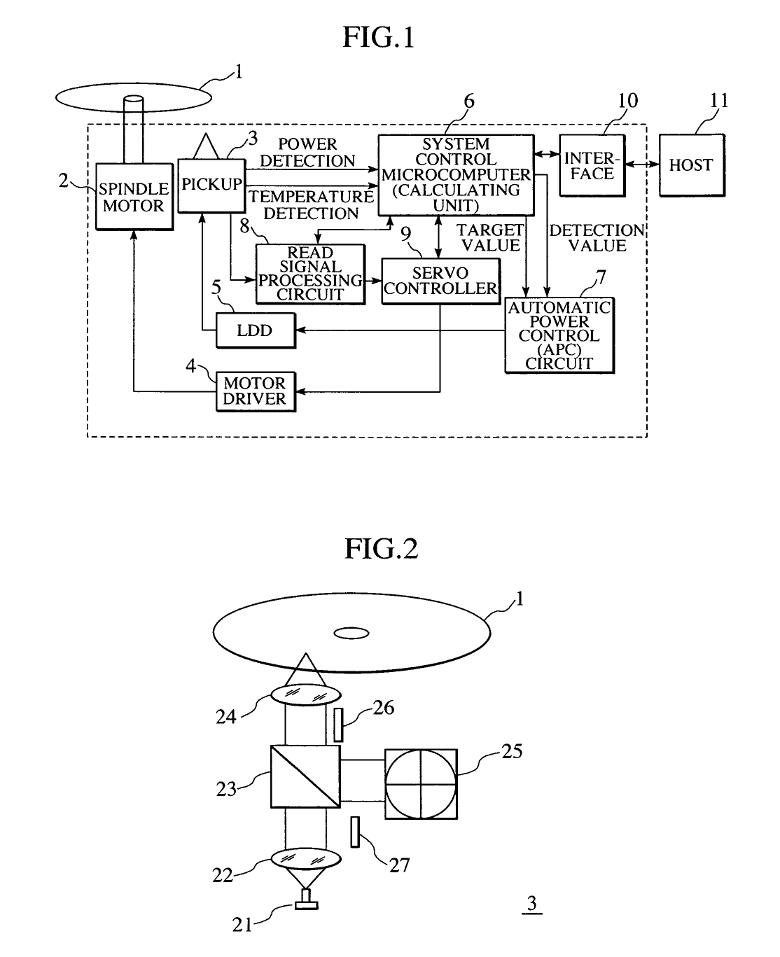

FIG. 1 is a block diagram showing an embodiment of an optical disc apparatus according to the present invention. The apparatus of the present embodiment rotates an optical disc 1 loaded therein using a spindle motor 2; and a pickup 3 applies laser light, generated by a semiconductor laser, to the recording side of the optical disc 1 to write or read data. The pickup 3 moves to a desired track position over the optical disc by a thread mechanism (not shown). A motor driver 4 supplies a rotational drive signal to the spindle motor 2.

A laser diode driving unit (LDD) 5 supplies a drive signal for laser emission to the pickup 3. The pickup 3 detects the power of the generated laser light and then transmits it to a system control microcomputer 6. The pickup 3 also detects the temperature in the pickup 3 and then transmits it to the system control microcomputer 6. The system control microcomputer (calculating unit) 6 calculates a target value for write/read of the laser power generated by the pickup 3 according to the temperature in the pickup 3. An automatic power control (APC) circuit 7 compares a power target value received from the system control microcomputer 6 with a power detection value detected by the pickup 3 and then transmits a control signal to an LDD 5 so that the pickup 3 generates laser light with the power based on the target value.

A read signal processing circuit 8 processes a signal read from the optical disc 1 to read data. The read data is processed by the system control microcomputer 6 and then transmitted to a host apparatus 11, such as a PC, via an interface 10. On the other hand, write data transmitted from the host apparatus 11 is converted to a predetermined writing signal and then written on the optical disc 1 with the power set by an APC circuit 7. A servo controller 9 controls motor rotation, tracking, focusing, etc. based on a read signal.

FIG. 2 is a diagram showing an example of internal configuration of the above-mentioned pickup 3. At the time of write/read operation, the optical beam generated by a laser diode (LD) 21 is converted into parallel light by a collimator lens 22 and then split into two different linearly-polarized light pieces (P-polarized and S-polarized light) whose polarizing directions perpendicularly intersect by a polarization beam splitter (PBS) 23. The P-polarized light advances straight and then is condensed on the disc surface by an objective lens 24. On the other hand, reflected light read from the disc reflects off the PBS23 and then enters an opto-electronic integrated circuit (OEIC) 25 for conversion to an electrical signal.

The pickup 3 includes a front monitor detector (FMD) 26, which is a power detector, to detect the laser power at a stage where an optical beam for write/read generated by the LD21 advances toward the objective lens 24 from the PBS23. A temperature sensor (temperature detector) 27 is installed in the pickup to detect the ambient temperature. The apparatus of the present embodiment is provided with a function to correct the characteristics of the objective lens 24 and FMD26 in the pickup if the characteristics fluctuate in response to the ambient temperature.

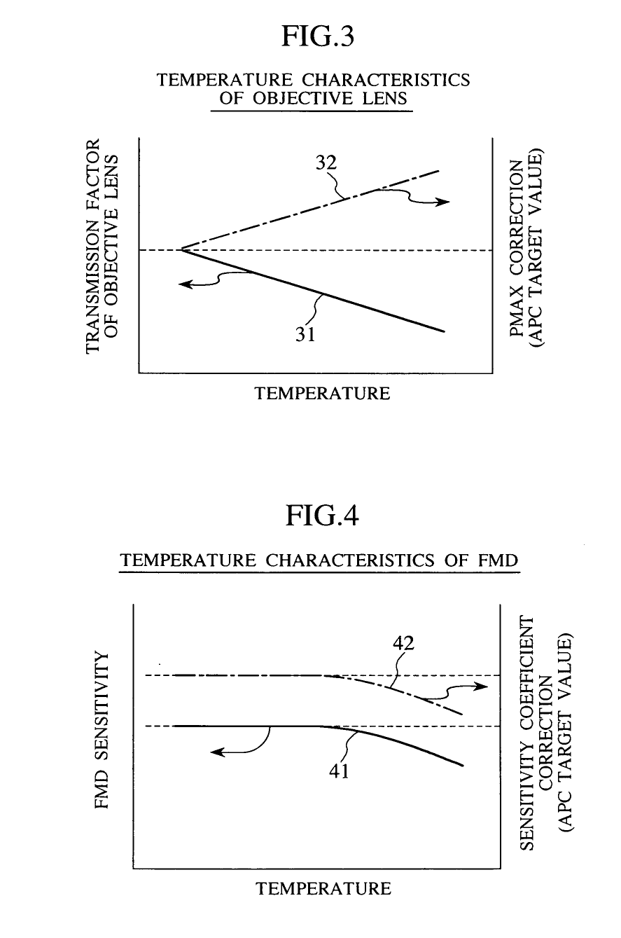

FIG. 3 is a diagram showing the temperature characteristics of an objective lens 24 and the corrected characteristics. As the temperature rises, the transmission factor of the objective lens (reference numeral 31) decreases. For example, if the temperature rises from 25(C. to 30(C., the transmission factor falls about 5%. As a result, the laser power applied to a disc surface decreases, degrading the write/read performance.

With the configuration of an actual pickup, since the FMD 26 for power detection must be installed at a position before the objective lens 24, the variation of laser power applied to the disc surface cannot directly be detected. Therefore, the temperature sensor 27 incorporated in the pickup detects the ambient temperature and corrects the variation of the transmission factor of the objective lens caused by temperature change. Specifically, the system control microcomputer (calculating unit) 6 changes the PMAX value, i.e., an coefficient which indicates the dynamic range of the emission light power for determining the emission light power of the laser diode with respect to the change of the transmission factor of the objective lens. More specifically, the system control microcomputer 6 corrects the PMAX value so that the change of the transmission factor be canceled (reference numeral 32), and calculates and sets a power target value (WRDA for writing or REDA for reading) of the APC circuit 7. This makes it possible to maintain a constant irradiation power on the disc surface.

FIG. 4 is a diagram showing the temperature characteristics of the front monitor detector (FMD) 24 and the corrected characteristics. The FMD detection sensitivity (reference numeral 41) decreases with increasing temperature. As a result, the laser power applied to the disc surface increases, degrading the write/read performance. Then, the temperature sensor 27 incorporated in the pickup detects the ambient temperature and corrects the variation of the FMD detection sensitivity caused by temperature change. Specifically, the system control microcomputer (calculating unit) 6 changes the FMD sensitivity coefficient for determining a target value with respect to the variation of the FMD detection sensitivity. In this case, the system control microcomputer 6 corrects the FMD sensitivity coefficient in the same direction as the direction of the change of the FMD detection sensitivity (reference numeral 42), and calculates and sets a power target value (WRDA for writing or REDA for reading) of the APC circuit 7. This makes it possible to maintain a constant irradiation power on the disc surface.

The above-mentioned temperature correction data (PMAX value and FMD sensitivity coefficient) are obtained in advance based on the temperature characteristics of the objective lens 24 and FMD26 and then stored, for example, in memory as firmware. In this case, correction data for each temperature are memorized in table form and the calculation of a target value at a desired temperature is performed with reference to this table. If the ambient temperature changes exceeding a predetermined value (threshold value), for example 5 degrees or more, the time during which write/read operation is interrupted for target value correction can be reduced by performing target value correction for APC control. It is also possible to store formulas for calculating and determining temperature correction data in the firmware and determine all target values through calculation using these formulas.

When setting a power target value (WRDA for writing or REDA for reading) in the APC circuit 7, the target value may be set by multiplying a calculated value by a predetermined coefficient (less than 100%) instead of setting a value obtained through calculation as a target value as it is (reflecting 100%). Thus, power control operation can be stabilized, without performing overshoot, by adding a damping factor even for a pickup with a large FMD sensitivity coefficient because of the variation in parts.

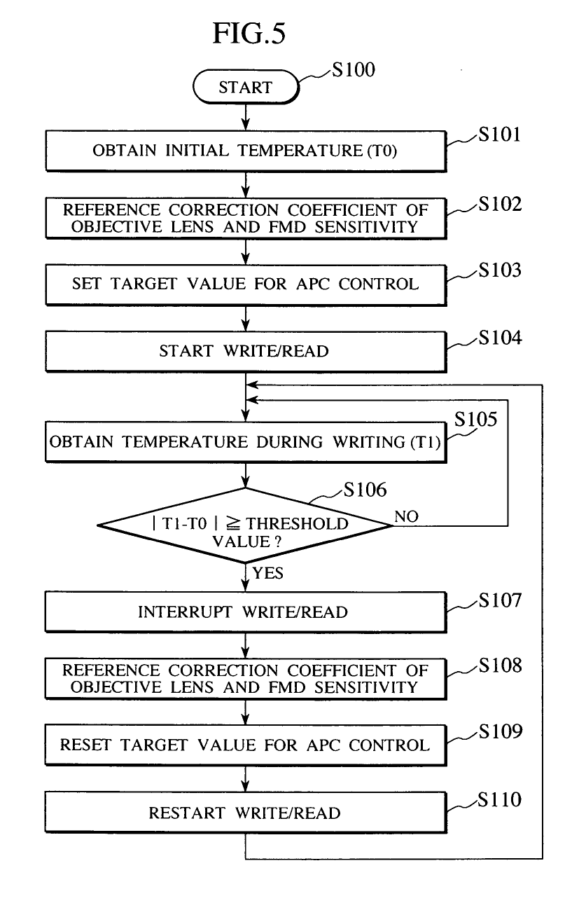

FIG. 5 is a flowchart showing an embodiment of a laser power control method according to the present invention. In Step S101, at the start of write/read operation, the temperature sensor 27 detects initial temperature T0 inside the pickup 3. In Step S102, the system control microcomputer 6 memorizes the detected temperature T0 in the memory (SRAM) in the microcomputer. Then, the system control microcomputer 6 reads out correction data of the objective lens 24 and FMD 26 (PMAX value and FMD sensitivity coefficient) at the detected temperature T0 with reference to the firmware and then calculates a target value (WRDA for writing or REDA for reading) of the laser power. Step S103 sets target power of the APC circuit 7 based on the calculated target value. Step S104 starts data write/read operation.

Step S105 detects temperature T1 inside the pickup 3 under write/read operation. In Step S106, the system control microcomputer 6 determines whether the temperature change from the initial temperature T0, |T1-T0|, exceeds a threshold value (for example, 5(C). If it is less than the threshold value (No in Step S106), the pickup continues write/read operation.

If the temperature change exceeds the threshold value (Yes in Step S106), Step S107 interrupts write/read operation. Step S108 reads out the correction data on the objective lens 24 and FMD 26 (PMAX value and FMD sensitivity coefficient) at the detected temperature T1 with reference to the firmware and then re-calculates a target value (WRDA for writing or REDA for reading) of the laser power. Step S109 resets the target power of the APC circuit 7 based on the calculated target value. Step S110 restarts write/read operation.

In accordance with the above-mentioned control, even if the temperature in the pickup 3 changes, the power of laser light applied to a disc can be kept constant, resulting in stable write/read characteristics.

In the present embodiment, the power target value of the APC circuit 7 is changed according to the temperature change. Alternatively, a configuration may be used in which the power target value is kept constant and the power detection value is corrected. Therefore, the amplifier gain of the amplifier circuit (not shown) of the FMD signal is changed according to the temperature characteristics of the objective lens and FMD sensitivity in response to the temperature change. Specifically, it is necessary, as correction of the amplifier gain, to make correction in the direction (inverted gradient) opposite to the above-mentioned correction curves of the PMAX value and FMD sensitivity coefficient in FIG. 3 and FIG. 4, respectively.

In the present embodiment, although the objective lens and FMD in the pickup were mentioned as components having temperature characteristics to be subjected to correction, temperature correction may be applied to either one. Temperature correction can also be applied to other optical and electronic components if the temperature characteristics affect the irradiation power to a disc.

### EMBODIMENT 2

Further, power control with higher accuracy can be realized through a combination of the temperature correction control mentioned in Embodiment 1 with a writing power optimization process (hereinafter referred to as Walking-OPC), as mentioned below.

With conventional Walking-OPC, the quality of data just before written is evaluated and optimal writing power is obtained for correction so that target quality may be obtained for the data to be written next. As an index for obtaining target quality, this method uses the amplitude (modulation factor) and asymmetry of a read signal and the relationship between amplitudes of the shortest mark and longest mark. With Walking-OPC, writing is continued based on a target value of a predetermined writing power within a certain section. Therefore, if the writing power applied to the disc surface varies within the section because of temperature change or the like, an optimum. power obtained as a result of Walking-OPC can be controlled so that it may not deviate from a true optimal value by setting a writing power through Walking-OPC including a result reflecting the correction.

Thus, the use of temperature correction control in the present embodiment together with Walking-OPC control makes it possible to suppress the variation of the power applied to a disc caused by temperature change during writing, resulting in sufficiently high-reliability optimal power obtained from the result of Walking-OPC. Therefore, writing power control with higher accuracy can be realized by setting this optimal value as a target value.

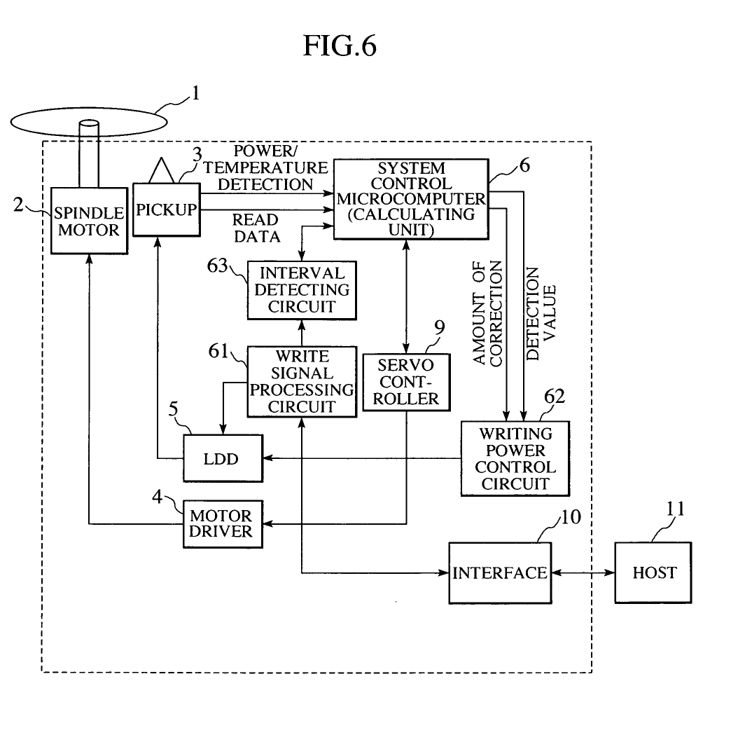

FIG. 6 is a block diagram showing another embodiment of an optical disc apparatus according to the present invention. With the present embodiment, a write signal processing circuit 61, a writing power control circuit 62, and a interval detecting circuit 63 have been added to the block diagram in FIG. 1 as components for performing Walking-OPC. In FIG. 6, the same reference numerals indicate the same components. FIG. 6 shows only components relevant to writing operation.

Since laser light applied to the optical disc 1 at the time of writing has higher writing power than at the time of reading, there is a large temperature rise in the pickup 3 occurring in emission of laser light. The temperature rise largely affects the variation of the transmission factor of lens, and fluctuation (degradation) of the write performance is expected. The system control microcomputer (calculating unit) 6 calculates the amount of writing power correction (target value) in response to the temperature change using a power detection signal and a temperature detection signal from the pickup 3; calculates the amount of writing power correction by evaluating the quality of read data and comparing it with target quality in Walking-OPC; then transfers these amounts of correction to the writing power control circuit 62. The writing power control circuit 62, based on the amounts of correction received from the system control microcomputer 6, controls the LDD 5 to set new writing power. Further, the write signal processing circuit 61 coverts the write data inputted from the host apparatus 11 through the interface 10 into a signal with a predetermined format and supplies it to the pickup 3 through the LDD 5. The interval detecting circuit 63 gives an instruction for performing Walking-OPC at predetermined intervals (timings).

When an instruction of Walking-OPC is received, the system control microcomputer 6 once stops write operation and confirms the writing power by Walking-OPC. In Walking-OPC, the microcomputer 6 reads data last written by the pickup 3 and, if the quality of read data has shifted from target quality, transfers the amount of writing power correction for correcting the shift to the writing power control circuit 62. The writing power control circuit 62 sets new writing power for the data to be written next and gives an instruction to the LDD 5, then restarts writing of the next data based on the new writing power.

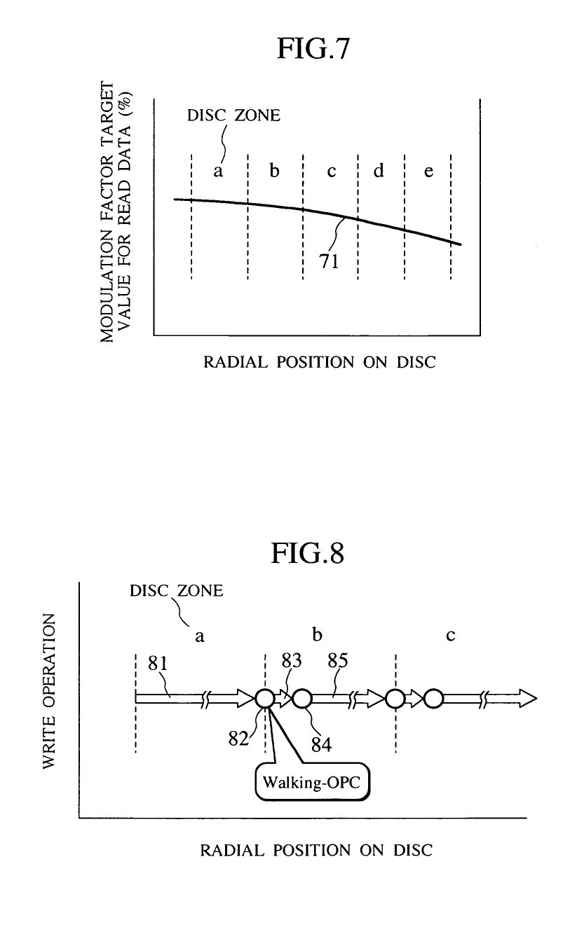

FIG. 7 is a diagram showing an example of a target value used as a reference when evaluating the quality of written data. In this example, the modulation factor is used as an index of quality, and the target value is set after being changed as shown by a curve 71 according to the radial position on the disc. The information of the target value is saved in advance in the system control microcomputer 6, and the writing power is confirmed with reference to the target value according to the radial position on the disc. Alternatively, it is also possible to divide the disc area shown in FIG. 7 into zones a to e along the radial direction and store the target value for each zone in table form.

FIG. 8 is a diagram showing an example of a timing at which Walking-OPC is performed. In this example, data writing is performed from the inner toward the outer circumference of the optical disc. Arrows 81, 83, and 85 show writing operations performed in succession. Each of circles 82 and 84 shows a timing of Walking-OPC. For example, writing is started from zone a (arrow 81) and once stopped at a boundary between zones a and b, then Walking-OPC (circle 82) is performed. Suppose that the writing power is corrected at this timing. In order to confirm correction result in Walking-OPC (circle 82), data is written in a short time with the corrected writing power (arrow 83) and Walking-OPC (circle 84) is performed again immediately thereafter. This makes it possible to improve the accuracy of writing power correction by confirming the corrected writing power.

An interval at which Walking-OPC is performed can arbitrarily be set by the interval detecting circuit 63 in FIG. 6. At this time, it is possible to perform writing with more appropriate writing power by properly setting the interval of Walking-OPC according to the characteristics of the optical disc as well as the situation of temperature change. With a multilayer disc, for example, a margin (tolerance) to writing power may be different for each layer. If a first layer is slightly affected (with a large margin) by writing power variation and a second layer is largely affected (with a small margin) by writing power variation, a long interval of Walking-OPC is set for the first layer and a short interval of Walking-OPC for the second layer. This makes it possible to efficiently perform writing power correction while reducing the number of Walking-OPC operations, preventing deviation of the writing power from the tolerance range in each layer.

Further, it is also possible to perform Walking-OPC each time temperature change exceeds a predetermined range (tolerance range). For example, if a margin to writing power is different for each layer like the above-mentioned multilayer disc, a large tolerance range of temperature change is set for the first layer and a small tolerance range of temperature change for the second layer. This makes it possible to efficiently perform writing power correction for each layer, preventing deviation of the writing power from the tolerance range.

Thus, a combination of the temperature correction control in Embodiment 1 with the control by the writing power optimization process (Walking-OPC) in this manner makes it possible to suppress the variation of the power applied to a disc caused by temperature change during writing and, as a result of Walking-OPC, to set an optimal writing power through correction. Consequently, the quality of write data can be further improved by controlling the value of writing power with a higher precision.

What is claimed is:

1. An optical disc apparatus which applies laser light to an optical disc to write or read data, comprising:
a pickup which generates laser light and applies it to the optical disc;
a power detector which detects the power of laser light generated by the pickup;
a temperature detector which detects temperature in the pickup;
a calculating unit which calculates a target value of the power of laser light generated by the pickup according to the detected temperature; and
a power control unit which compares power detected by the power detector with a target value calculated by the calculating unit and then performs control so that the pickup generates laser light with the power based on the target value.

2. An optical disc apparatus according to claim 1, further comprising:
a memory which stores correction data used for correcting temperature characteristics of transmission factor of an objective lens included in the pickup,
wherein the calculating unit calculates a target value of the power of laser light using the correction data stored in the memory.

3. An optical disc apparatus according to claim 1, further comprising:
a memory which stores correction data used for correcting temperature characteristics of detection sensitivity of the power detector included in the pickup,
wherein the calculating unit calculates a target value of the power of laser light using the correction data stored in the memory.

4. An optical disc apparatus which applies laser light to an optical disc to write or read data, comprising:
an interface which exchanges writing or reading data with an externally connected host apparatus;
a signal processing unit which processes data written or read on the optical disc;
a spindle motor which rotates the optical disc;
a pickup which generates laser light and applies it to the optical disc;
a power detector which detects the power of laser light generated by the pickup;
a temperature detector which detects temperature in the pickup;
a calculating unit which calculates a target value of the power of laser light generated by the pickup according to the detected temperature; and
a power control unit which compares power detected by the power detector with a target value calculated by the calculating unit and then performs control so that pickup generates laser light with the power based on the target value.

5. An optical disc apparatus which applies laser light to an optical disc to write or read data;
a spindle motor which rotates the optical disc;
a pickup which generates laser light and applies it to the optical disc;
a temperature detector which detects temperature in the pickup; and
a power control unit which performs control so that the power of laser light to be applied to the optical disc by the pickup remains constant even if the detected temperature changes;

6. A laser power control method in an optical disc apparatus, the method comprising the steps of:
detecting temperature in the pickup which applies laser light to an optical disc;
detecting the power of laser light generated by the pickup;
setting a target value of the laser light power according to the detected temperature; and
performing control so that the pickup generates laser light with the power based on the set target value.

7. A laser power control method according to claim 6, wherein
the target value of the power of laser light is set in such a manner as to correct temperature characteristics of transmission factor of an objective lens included in the pickup.

8. A laser power control method according to claim 6, wherein
the target value of the power of laser light is set in such a manner as to correct temperature characteristics of detection sensitivity of the power detector included in the pickup.

9. A laser power control method according to claim 6, wherein
the target value is changed and set if the detected temperature changes exceeding a threshold value.

10. A laser power control method in an optical disc apparatus, the method comprising the steps of:
detecting temperature in the pickup which applies laser light to an optical disc;
detecting the power of laser light generated by the pickup;
setting a target value of the power of laser light according to the detected temperature;
performing control so that the pickup generates laser light with the power based on the set target value;
writing data on an optical disc with the controlled power;
evaluating the quality of the written data; and
correcting a target value of the power so that the quality of the data coincides with a desired quality.

11. An optical disc apparatus which applies laser light to an optical disc to write data, comprising:
a pickup which generates laser light and applies it to the optical disc;
a power detector which detects the writing power of laser light generated by the pickup;
a temperature detector which detects temperature in the pickup;
a write signal processing unit which converts the data to be written into a signal with a predetermined format and supplies it to the pickup;
an interval detecting unit which gives an instruction for performing a writing power optimization process at predetermined intervals;
a calculating unit which calculates the amount of writing power correction of laser light generated by the pickup according to the detected temperature and at the same time calculates the amount of writing power correction by evaluating the quality of written data in the writing power optimization process; and
a writing power control unit which sets new writing power of laser light generated by the pickup, based on each of the amounts of correction calculated by the calculating unit.

12. An optical disc apparatus according to claim 11, wherein
the calculating unit holds target quality for each record position of the optical disc in advance, and calculates the amount of writing power correction by comparing the quality of the written data with the target value, in the writing power optimization process.

13. An optical disc apparatus according to claim 11, wherein
the interval detecting unit sets an interval at which the writing power optimization process is to be performed according to a tolerance range of the writing power for the optical disc.

14. A laser power control method used when writing data to an optical disc, the method comprising the steps of:
detecting temperature in the pickup which applies laser light to an optical disc;
detecting the writing power of laser light generated by the pickup;
calculating the amount of correction of the writing power detected according to the detected temperature;
reading written data by once stopping write operation as a writing power optimization process;
calculating the amount of writing power correction by comparing the quality of read data with target quality; and
setting new writing power of laser light based on each of the calculated amounts of correction.

15. A laser power control method according to claim 14,
wherein, when the optimization process is performed, the optimization process is performed again immediately thereafter with regard to the data written by the newly set writing power.
